(19) United States
(12) Patent Application Publication
(10) Pub. No.: US 2013/0084138 A1
(43) Pub. Date: Apr. 4, 2013

(54) POWERED PARTICULATE LOADER AND TRANSFER APPARATUS

(71) Applicant: Paul Kerr, Hodgeville (CA)

(72) Inventor: Paul Kerr, Hodgeville (CA)

(21) Appl. No.: 13/704,011

(22) PCT Filed: Jun. 13, 2011
(86) PCT No.: PCT/CA11/00691

§ 371 Date: Dec. 13, 2012

(30) Foreign Application Priority Data
Jun. 14, 2010 (CA) 2,707,408

(51) Int. Cl. B65G 53/66; B65G 53/60

(52) U.S. Cl. CPC B65G 53/66; B65G 53/60
USPC 406/10

(57) ABSTRACT

A particulate loader and transfer apparatus is provided. The particulate loader and transfer apparatus comprises a separation chamber having a particulate and air intake. At least one blower is connected to the separation chamber for providing suction thereto. A particulate transporting device is connected to the separation chamber. An internal combustion engine and a drive mechanism operatively engage the at least one blower and the particulate transporting device. A control mechanism electronically controls the speed of the internal combustion engine.

### FIELD OF THE INVENTION

The present invention relates to a powered high capacity particulate loader and transfer apparatus for grains, fertilizers, chemicals, particulates and granular material (hereinafter referred to as “particulates”), and more particularly, relates to an improved particulate loader and transfer apparatus powered by a diesel or other internal combustion engine.

### BACKGROUND OF THE INVENTION

Particulate loader and transfer devices are well known, and as described in U.S. Pat. No. 7,431,537, may be used by farmers and others to load and transfer grain and other particulates in a convenient manner. These devices may include, for example, one or more blowers to create suction within an air-materials separation chamber and a vacuum pickup hose attached thereto, to transport grain or other materials from one location, into the air-materials separation chamber in the bottom of which is positioned an auger for transferring the grain or other particulate material from the air-materials separation chamber into, for example an open truck, container or other location.

Generally, the blower includes either a radial or centrifugal blower which draws the air from the air-materials separation chamber and the vacuum pickup hose extending therefrom, and exhausts the air to the atmosphere in an area adjacent to the particulate loader and transfer device. The radial or centrifugal blowers are useful in transporting large volumes of air and particulate material quickly and efficiently, which is particularly desirable in the context of particulate loader and transfer devices. In some prior art particulate loader and transfer devices, the particulate loader and transfer device is driven by way of, for example, a power takeoff of, for example, a tractor. However, this is disadvantageous in some circumstances a tractor is a relatively expensive machine to own, operate and maintain. Other prior art particulate loader and transfer devices have dedicated diesel or other internal combustion engines for powering the blower and other components of the particulate loader and transfer device. For example, particulate loader and transfer devices have utilized diesel engines that directly drive the particulate loader and transfer device, both the diesel engine and particulate loader and transfer device being mounted to a common frame, and having a drive shaft from the diesel engine to power the particulate loader and transfer device. In this example, the diesel engine utilizes a mechanical governing system to govern the engine speed of the diesel engine in a conventional manner, the mechanical governor being based upon, for example, a centrifugal flyball technology or viscous fluid resistance technology that is combined with mechanical linkages to the diesel engine injector pump to regulate the fuel to the injectors and thereby govern the engine speed of the diesel engine.

It is desirable to have a portable, diesel engine powered particulate loader and transfer device with a governed electronic engine speed/rpm control.

Furthermore, it is desirable to have a portable, diesel engine powered particulate loader and transfer device with a governed electronic engine speed/rpm control wherein the engine speed/rpm is controlled by means of an electronic engine control unit, the electronic engine control unit adjusting and controlling the timing of the diesel injectors and the volume of the fuel injected on each occasion to maintain the speed of the diesel at a specified speed, or within a range of specific speeds, the electronic engine control unit making such adjustments to the diesel injector timing and volume of the fuel injected on each injector pulse to maintain the speed specified as load conditions vary.

Furthermore, it is desirable to have a portable, diesel engine powered particulate loader and transfer device that may be used in one embodiment to limit the torque generated by the diesel engine to drive the diesel engine powered particulate loader and transfer device, or alternatively to allow for a higher torque for a specified period of time to manage a temporary increase in the load on the particulate loader and transfer device, the electronic engine control unit being programmed to permit the higher torque for limited periods of time only.

Furthermore, it is desirable to have a portable, diesel engine powered particulate loader and transfer device having an electronic engine control unit that is preprogrammed to require regular maintenance based upon engine hours, disabling operation of the engine until the maintenance has been performed, or providing warning lights or other indicia to communicate to the operator that maintenance is overdue.

### SUMMARY OF THE INVENTION

Accordingly, one object of the present invention is to provide a portable, diesel engine powered particulate loader and transfer device with a governed electronic engine speed/rpm control.

Another object of the present invention is to provide a portable, diesel engine powered particulate loader and transfer device with a governed electronic engine speed/rpm control wherein the engine speed/rpm is controlled by means of an electronic engine control unit , the electronic engine control unit adjusting and controlling the timing of the diesel injectors and the volume of the fuel injected on each injector pulse to maintain the speed of the diesel at a specified speed, or within a range of specific speeds, the electronic engine control unit making such adjustments to the diesel injector timing and volume of the fuel injected on each injector pulse to maintain the speed specified as load conditions vary.

Another object of the present invention is to provide a device that may be used in one embodiment to limit the torque generated by the diesel engine to drive the diesel engine powered particulate loader and transfer device, or alternatively to allow for a higher torque for a specified period of time to get over temporary increase in the load on the particulate loader and transfer device, the electronic engine control unit being programmed to permit the higher torque for limited periods of time only.

Another object of the present invention is to provide a portable, diesel engine powered particulate loader and transfer device having an electronic engine control unit that is preprogrammed to require regular maintenance based upon engine hours, disabling operation of the engine until the maintenance has been performed, or providing warning lights or other indicia to communicate to the operator that maintenance is overdue.

According to one aspect of the present invention, there is provided a particulate loader and transfer apparatus. The particulate loader and transfer apparatus comprises a separation chamber having a particulate and air intake. At least one blower is connected to the separation chamber for providing suction thereto. A particulate transporting device is connected to the separation chamber. An internal combustion engine and a drive mechanism operatively engage the at least one blower and the particulate transporting device. A control mechanism electronically controls the speed of the internal combustion engine.

According to the aspect of the present invention, there is provided a method for controlling operation of an internal combustion engine driving a particulate loader and transfer apparatus. A particulate loader and transfer apparatus is provided with the particulate loader and transfer apparatus comprising a separation chamber having a particulate and air intake. At least one blower is connected to the separation chamber for providing suction thereto. A particulate transporting device is connected to the separation chamber. An internal combustion engine and a drive mechanism operatively engage the at least one blower and the particulate transporting device. Using an electronic control mechanism the speed of the internal combustion engine is electronically controlled.

An advantage of the present invention is that it provides a portable, diesel engine powered particulate loader and transfer device with a governed electronic engine speed/rpm control.

A further advantage of the present invention is that it provides a portable, diesel engine powered particulate loader and transfer device with a governed electronic engine speed/rpm control wherein the engine speed/rpm is controlled by means of an electronic engine control unit, the electronic engine control unit adjusting and controlling the timing of the diesel injectors and the volume of the fuel injected on each injector pulse to maintain the speed of the diesel at a specified speed, or within a range of specific speeds, the electronic engine control unit making such adjustments to the diesel injector timing and volume of the fuel injected on each injector pulse to maintain the speed specified as load conditions vary.

A further advantage of the present invention is that it may also be used in one embodiment to limit the torque generated by the diesel engine to drive the diesel engine powered particulate loader and transfer device, or alternatively to allow for a higher torque for a specified period of time to get over temporary increase in the load on the particulate loader and transfer device, the electronic engine control unit being programmed to permit the higher torque for limited periods of time only.

A further advantage of the present invention is that it provides a portable, diesel engine powered particulate loader and transfer device having an electronic engine control unit that is preprogrammed to require regular maintenance based upon engine hours, disabling operation of the engine until the maintenance has been performed, or providing warning lights or other indicia to communicate to the operator that maintenance is overdue.

### BRIEF DESCRIPTION OF THE DRAWINGS

A preferred embodiment of the present invention is described below with reference to the accompanying drawings, in which:

FIG. 1 is a top view of one embodiment of the present invention;

FIG. 2 is an inlet side view of one embodiment of the present invention;

FIG. 3 is an auger outlet side view of one embodiment of the present invention; and,

FIG. 4 is a simplified diagram illustrating an ECU of one embodiment of the present invention.

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While the description of the preferred embodiments herein below is with reference to a diesel engine, it will become evident to those skilled in the art that the preferred embodiments of the invention are not limited thereto, but are also applicable for other types of internal combustion engines such as, for example, 2-stroke and 4-stroke gasoline engines.

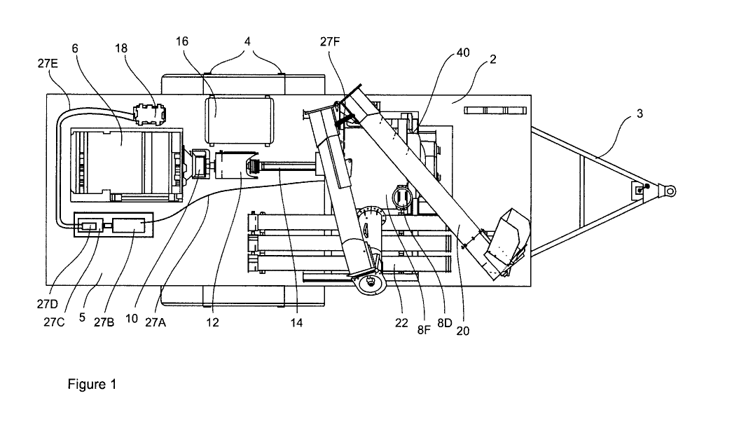

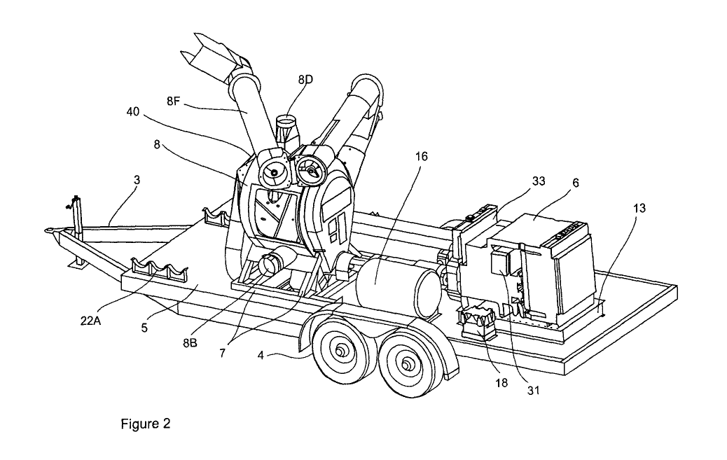

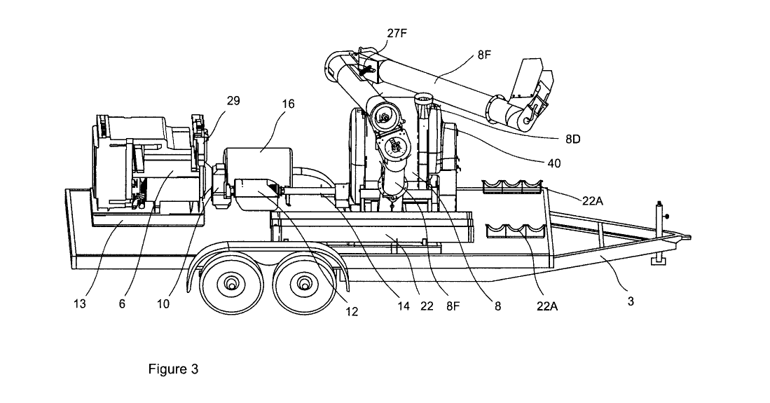

In a preferred embodiment of the present invention, as illustrated in FIGS. 1, 2 and 3, an improved particulate loader and transfer apparatus powered by a diesel or other internal combustion engine is provided, having, in a preferred embodiment, a trailer 2, preferably having wheels 4 conventionally mounted thereto by single or preferably multiple axles, the trailer 2 preferably being towable by means of a conventional tongue 3 and hitch assembly, the trailer 2 preferably having a hardwood deck 5, and proximate one end thereof, a particulate loader and transfer apparatus 8 (having a separation chamber 8A, having a particulate and air intake 8B, an air outlet 8D, a blower 40 and an auger 8F (shown in the collapsed “folded for transport” position) or other particulate transporting device) being mounted thereto by means of a subframe 7 member that securely attaches the particulate loader and transfer apparatus 8 to the hardwood deck 5, the particulate loader and transfer apparatus 8 having a particulate and air intake 8B for the receipt of particulate materials, an air outlet 8D to discharge air, and a collapsible auger 8F. In the preferred embodiment of the present invention, a diesel engine 6 is, for example and preferably by way of a subframe member 13 securely attached to the hardwood deck 5, the output shaft of the diesel engine being preferably attached to a clutch 10 and a speed reducer 12, and thereafter, to a drive shaft 14 to drive the blower and other components of the particulate loader and transfer device 8. An oversized fuel tank 16 and battery 18 are also preferably mounted to the hardwood deck 5 in a conventional manner and are connected to the diesel engine 6 for providing fuel and electrical power to the diesel engine 6 and other components as needed, a storage tank 33 preferably being mounted to or proximate the diesel engine to provide fluids such as oil and coolant to the diesel engine in a conventional manner. In the preferred embodiment of the present invention, storage means 22A mounted to the deck 5 is provided for the storage of one or more lengths of hose 22 for attachment to the particulate and air intake 8B in the conventional manner. In the preferred embodiment of the present invention, the diesel engine is of a size to provide sufficient horsepower to effectively drive the blower and other components of the particulate loader and transfer device. For example, in the case of the REM 2700 particulate loader and transfer device, a Deutz diesel engine having 131 horsepower may be utilized, having a maximum speed of 2400 rpm, it being understood that in the case of differently sized and differently configured particulate loader and transfer devices, differently sized diesel engines may alternatively be utilized, and would generally be within a range of between 80 hp and 250 hp. In the preferred embodiment of the present invention, in the case of the REM 2700 particulate loader and transfer device, a 2.14:1 speed reducer is utilized, so that if the diesel engine output is governed or set at 2150 rpm as hereinafter described, the drive shaft 14 is driven at a rotational speed at, or approximately at, the preferred speed of the REM 2700 particulate loader and transfer device.

In the preferred embodiment of the present invention, an engine control unit (ECU) 31 is provided and operatively connected to the diesel engine, the ECU 31 being preferably set to have a constantly maintained diesel engine crankshaft rotational speed. For example, in the case of the REM 2700 particulate loader and transfer device operating for grain or corn use, the ECU 31 is preferably set at 2150 rpm (and may vary depending on the particulate material being handled), the ECU 31 adjusting and controlling the timing of the injectors and the volume of the fuel injected on each injector pulse to maintain the speed of the diesel at a specified speed, or within a range of specific speeds, the ECU 31 making such adjustments to the injector timing and volume of the fuel injected on each injector pulse to maintain the speed specified as load conditions vary, it being understood that the ECU can be used to modify the diesel engine's output speed on various different diesel engines, by varying different means, including for example, by varying fuel pressure, fuel volume injected, timing and injection dwell, the ECU being adapted to provide for each as appropriate for the various different diesel engines.

In the preferred embodiment of the present invention, a crank shaft revolution signal generator (not shown) adapted to generate a signal related to the engine's current speed, or the length of time for the engine's crank shaft to complete a full rotation is provided on the diesel engine, preferably in the form of a magnet (not shown) connected to the crank shaft or flywheel of the engine, the ECU 31 being preferably provided with an RPM Set Point (that is, the desired diesel engine speed), and when in operation, the ECU 31 compares the engine's current speed with the RPM Set Point, the ECU 31 adjusting as necessary the injector parameters (injector timing and volume of the fuel injected on each injector pulse) to cause the engine to match the Set Point or to be maintained within the specified range of the Set Point. It is understood that the engine speed input to the ECU 31 may be derived from a measurement of the rotational speed of the engine's crankshaft, or by other means known to a person skilled in the art.

In one embodiment, the RPM Set Point for various different particulate loader and transfer devices are preprogrammed into the ECU 31, providing a simple mechanism for altering the diesel engine's speed in correspondence with the specifications of the various different particulate loader and transfer devices.

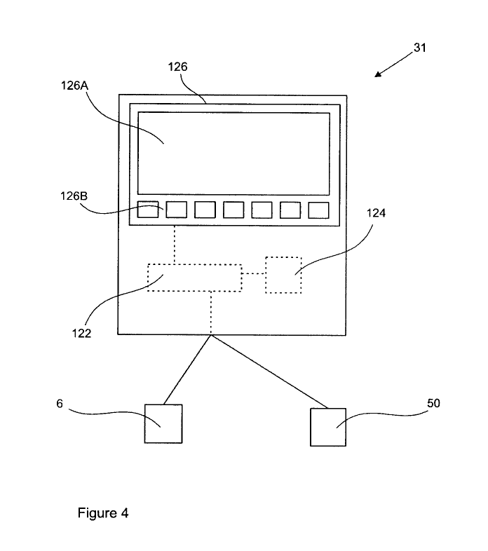

Referring to FIG. 4, a preferred embodiment of the ECU 31 is provided. Operation of the ECU 31 is enabled using an off-the-shelf computer processor 122 for executing executable commands preferably stored in non-volatile memory 124 such as, for example, a hard-drive or flash memory. The processor 122 is connected to sensors of the diesel engine 6—such as, for example, temperature sensors, pressure sensors, and the crank shaft revolution signal generator—for receiving sensor data there from and to components of the diesel engine such as, for example, the injector. Optionally, the processor 122 is also connected to a pressure sensor 50 disposed inside the separation chamber 8A for receiving sensor data indicative of a pressure inside the separation chamber 8A enabling, for example, control of the speed of the diesel engine such that the pressure in the separation chamber 8A is within a predetermined range.

A user interface 126 is disposed in the ECU 31 and connected to the processor 122 for displaying display data to the operator 126A in a human comprehensible fashion and for receiving operator commands 126B. For example, the operator is enabled to provide user input data related to the control of speed such as a range of speeds for operating the particulate loader and transfer apparatus 8. Optionally, the operator provides input data indicative of at least one of type and condition of the particulate—for example, grain and dry—by selecting, for example, from a displayed menu listing various types of particulate and conditions of the particulate the particulate loader and transfer apparatus 8 is designed to handle. The processor 122 then determines an appropriate range of speeds, for example, by accessing a look-up table stored in the memory 124, which is indicative of the various types and conditions of the particulate and the associated appropriate ranges of speeds. The data associating the types and conditions of the particulate with the appropriate ranges of speeds are determined, for example, in an empirical fashion and/or using conventional engineering technology

The user interface 126 is provided using, for example, an off-the-shelf touch screen or a combination of a display and push buttons. Preferably, the ECU is provided in a rugged fashion for outdoor use and to withstand substantial vibrations generated during transport and operation of the particulate loader and transfer apparatus 8.

Preferably, the ECU 31 is adapted to prevent or substantially eliminate over-speed issues. For example, when a hose connected to the particulate and air intake 8B is getting plugged the incoming flow of air and particulate suddenly drops. As a consequence, the load acting on the centrifugal blower 40 also drops suddenly resulting in a sudden increase in speed of the blower 40 and the diesel engine 6 creating a potentially damaging and hazardous situation. Using the ECU 31 for electronically controlling the engine to maintain the speed within a predetermined range or below a predetermined maximum speed enables a more flexible and a substantially faster reaction in such a situation than conventional controls based on, for example, centrifugal flyball technology or viscous fluid resistance technology.

A Maximum Allowable RPM may be entered into the ECU 31, preferably set at, or slightly above or below the actual maximum speed of the particulate loader and transfer device, and when the Maximum Allowable RPM is exceeded, the ECU 31 will reduce or alternatively shut off fuel supply to the diesel engine until the diesel engine returns to a speed lower than the Maximum Allowable RPM. In one embodiment of the present invention, this Maximum Allowable RPM can be permanently stored in the ECU 31 to minimize the potentially hazardous “tinkering” that an operator might try in an effort to improve machine performance.

Further advantageously, the present invention as described herein may also limit the torque generated by the diesel engine, or alternatively allow for a higher torque for a specified period to get over temporary increases in the load, the ECU 31 being programmed to permit the higher torque for limited periods of time only, it being understood that the “extra” power will be always minimized to avoid high wear/fuel consumption. This feature allows the unit to enjoy the operation performance similar to that of an electric motor such that the unit can have a power output higher than the rated power for short periods of time.

Temporary increases of load arise, for example, when suddenly less particulate is picked up with the hose and, therefore, the incoming flow of particulate and air experiences an increase of the amount of air therein which has to be removed by the blower 40 to ensure a substantially constant incoming flow.

In one embodiment of the present invention, the ECU 31 is preprogrammed to require regular maintenance on the diesel engine and/or particulate loader and transfer device based upon engine hours (by disabling operation of the engine until the maintenance has been performed, or providing warning lights or other indicia to communicate to the operator that maintenance is overdue). In one embodiment of the present invention, the ECU 31 is preprogrammed to permit the operator to acknowledge the warning light or other indicia and to permit the operator to by-pass the ECU's above-referenced disabling operation, allowing the operator to continue to use the device notwithstanding the outstanding overdue maintenance item that was the subject of the warning light or other indicia.

In one embodiment of the present invention, the ECU 31 is preprogrammed to receive and/or calculate information relating to the total volume of fuel consumed and/or for a period of time, this information being useful for engine maintenance and repair issues for items that are “power” based and not really by hours of operation, such as, for example, fuel and hydraulic filters.

In one embodiment of the present invention, hydraulic cylinders 27F are used to reposition the auger from the closed position illustrated in FIGS. 1, 2 and 3, to the open fully extended position, about pivots 27G, pressurized hydraulic fluid being provided to the hydraulic cylinders 27F by way of hydraulic lines 27A supplied by a hydraulic pump 27B driven as needed by an electric motor 27C, powered by the battery 18, electric power being supplied to the electric motor by way of electric lines 27E between the battery 18 and the electric motor 27C and being controllable by the operator who may use a reversible electric switch or toggle 27D to extend or retract the hydraulic cylinders 27F and thereby raise or lower the auger in a conventional manner.

The present invention has been described herein with regard to preferred embodiments. However, it will be obvious to persons skilled in the art that a number of variations and modifications can be made without departing from the scope of the invention as described herein.

1. A particulate loader and transfer apparatus comprising:
a separation chamber having a particulate and air intake;
at least one blower connected to the separation chamber for providing suction thereto;
a particulate transporting device connected to the separation chamber;
an internal combustion engine;
a drive mechanism connected to the internal combustion engine for operatively engaging the at least one blower and the particulate transporting device with the internal combustion engine; and,
a control mechanism for electronically controlling the speed of the internal combustion engine.

2. A particulate loader and transfer apparatus as defined in claim 1 wherein the control mechanism comprises a processor.

3. A particulate loader and transfer apparatus as defined in claim 2 wherein the control mechanism comprises a user interface connected to the processor for receiving user commands and for displaying display data to a user.

4. A particulate loader and transfer apparatus as defined in claim 3 comprising non-volatile memory connected to the processor, the memory having stored therein executable commands for execution on the processor.

5. A particulate loader and transfer apparatus as defined in claim 1 wherein the internal combustion engine is a diesel engine.

6. A method for controlling operation of an internal combustion engine driving a particulate loader and transfer apparatus comprising:
providing a separation chamber having a particulate and air intake;
providing at least one blower connected to the separation chamber for providing suction thereto;
providing a particulate transporting device connected to the separation chamber;
providing a drive mechanism connected to the internal combustion engine for operatively engaging the at least one blower and the particulate transporting device with the internal combustion engine;
using an electronic control mechanism electronically controlling the speed of the internal combustion engine.

7. A method as defined in claim 6 comprising maintaining the speed within a predetermined range of speeds as load conditions vary.

8. A method as defined in claim 7 wherein the speed is maintained within the predetermined range in a situation of a sudden drop of the load acting on the at least one blower.

9. A method as defined in claim 7 wherein the speed is maintained below a predetermined maximum speed in a situation of a sudden drop of the load acting on the at least one blower.

10. A method as defined in claim 6 comprising receiving user input data related to the control of the speed.

11. A method as defined in claim 10 comprising receiving user input data indicative of a range of speeds.

12. A method as defined in claim 11 comprising:
receiving user input data indicative of at least one of type and condition of the particulate; and,
determining a range of speeds in dependence upon the user input data.

13. A method as defined in claim 7 comprising:
receiving data indicative of a pressure in the separation chamber; and,
controlling the speed of the internal combustion engine such that the pressure in the separation chamber is within a predetermined range.

14. A method as defined in claim 7 wherein the speed is controlled by varying at least one of:
fuel pressure; fuel volume injected; injection timing; and, injection dwell.

15. A method as defined in claim 6 comprising enabling provision of power higher than a rated power for a predetermined period of time in a situation of an increase of the load acting on the at least one blower.
